(19) United States
(12) Patent Application Publication
(10) Pub. No.: US 2013/0106039 A1
(43) Pub. Date: May 2, 2013

(54) LID STERILIZATION APPARATUS

(71) Applicant: Mark Gallegos, Clearfield, UT (US)

(72) Inventor: Mark Gallegos, Clearfield, UT (US)

(21) Appl. No.: 13/284,149

(22) Filed: Oct. 28, 2011

(51) Int. Cl. B25B 11/00

(52) U.S. Cl. 269/10

(57) ABSTRACT

A lid sterilization apparatus comprises a number of fingers to retain a number of canning lids between the fingers. The fingers comprise a contour that matches the contour of a canning lid, and a stopper to prevent a canning lid from being inserted between the fingers beyond a predefined point. A lid sterilization apparatus comprises a handle, a column coupled to the handle, a horizontal arm perpendicularly coupled to the column, a mounting arm coupled to the horizontal arm, and a number of fingers coupled to the mounting arm to retain a number of canning lids between the fingers. The mounting arm is coupled to the horizontal bar approximately perpendicular to the column and horizontal bar.

### BACKGROUND

Sterilization is a process under which bacteria or other microbial life is destroyed on a surface of an item. Heat is one method of sterilizing an object and is often applied to the various tools used in connection with food processing. As applied to canning, for example, both the bottles and lids are sterilized to prevent bacteria from later forming inside the jar. This is to avoid the situation where, sometime later, the consumer is exposed to botulism or other kinds of food poisoning due to the spoiling of the foodstuffs contained within the jar.

During a canning or preservation process, the lids are placed into boiling water. After exposure to the boiling water, the lids are sterilized and the user may take them out and place them on the tops of the individual bottles. When moving the hot lids from the boiling water to the tops of the bottles, however, the lids may be once again exposed to bacteria due to interaction with the user's hands or other surfaces that have been contaminated. Further, even if the user is able to properly wash his or her hands, and handle the lids as little as possible, the user still extracts the lids out of the boiling water. Removal of the lids from boiling water may result in burns to the user's hands.

Still further, a user may simply place the lids into the bottom of a container of boiling water. This method of boiling lids does not always provide for complete sterilization of each lid and does not ensure that the elastomeric material included on the lids for sealing purposes will be rendered tacky. For example, a number of lids, during the boiling process, may mate with one another, leaving a number of the sides of lids unexposed to the boiling water. This may leave the mated sides of the canning lids unsterilized, and may prohibit the elastomeric material of a number of the lids from becoming tacky.

### BRIEF DESCRIPTION OF THE DRAWINGS

The accompanying drawings illustrate various examples of the principles described herein and are a part of the specification. The illustrated examples do not limit the scope of the claims.

FIG. 1 is a perspective view of a lid sterilization apparatus, according to an example of principles described herein.

FIG. 2 is a cross-sectional side view of the lid sterilization apparatus of FIG. 1, according to an example of principles described herein.

FIG. 3 is a cross-sectional side view of the lid-mounting portion of the lid sterilization apparatus of FIG. 2, according to an example of principles described herein.

FIG. 4 is a side view of the lid sterilization apparatus of FIG. 1 with canning lids engaged therewith, according to an example of the principles described herein.

FIG. 5A is a top view of a finger of the lid sterilization apparatus, according to an example of the principles described herein.

FIG. 5B is a top view of a finger of the lid sterilization apparatus, according to another example of the principles described herein.

FIG. 6 is a cross-sectional side view of a lid sterilization apparatus engaged with a container for boiling of the canning lids, according to an example of the principles described herein.

FIG. 7 is a side view of a lid sterilization apparatus of FIG. 1 used to engage a canning lid onto a canning jar, according to an example of the principles described herein.

FIG. 8 is a cross-sectional side view of a lid sterilization apparatus, according to another example of principles described herein.

FIG. 9 is a side view of a lid sterilization apparatus, according to still another example of principles described herein.

FIG. 10 is a front view of the lid sterilization apparatus of FIG. 9, according to an example of principles described herein.

FIG. 11 is a front view of the lid sterilization apparatus of FIGS. 9 and 10 used to engage a canning lid onto a container, according to an example of the principles described herein.

FIG. 12 is a side view of a lid sterilization apparatus with canning lids engaged therewith, according to still another example of the principles described herein.

FIG. 13 is a front view of the lid sterilization apparatus of FIG. 12, according to an example of principles described herein.

FIG. 14 is a side view of a lid sterilization apparatus with canning lids engaged therewith, according to still another example of the principles described herein.

FIG. 15 is a front view of the lid sterilization apparatus of FIG. 14, according to an example of principles described herein.

Throughout the drawings, identical reference numbers designate similar, but not necessarily identical, elements.

### DETAILED DESCRIPTION

The present specification therefore describes a lid sterilization apparatus that allows the user to safely and more easily sterilize lids and engage them with a canning jar. In one example, the lid sterilization apparatus comprises a number of fingers to retain a number of canning lids between the fingers, the fingers comprising a contour that matches the contour of a canning lid, and a stopper to prevent a canning lid from being inserted between the fingers beyond a predefined point.

A mounting arm of a canning lid sterilization apparatus comprises a number of fingers coupled to the mounting arm to engage with a number of canning lids. The fingers comprise a first finger, a number of intermediary fingers, and a base finger. The first finger comprises a distal peak located furthest from the mounting arm, a proximal peak located relatively closer to the mounting arm than the distal peak, and a trough located between the distal peak and the proximal peak. The number of intermediary fingers comprise the distal peak, the proximal peak, the trough, and a stopper to prevent a canning lid from being inserted between the fingers beyond a predefined point. The base finger comprises the stopper to prevent a canning lid from being inserted between the fingers beyond a predefined point.

The lid sterilization apparatus individually separates canning lids engaged therewith. This limits touching of sterilized lids. Further, the lid sterilization apparatus reduces potential injuries to a user because the user does not fish out lids from the bottom of a container of boiling water. Still further, individual separation of the canning lids ensures that all the canning lids are sufficiently sterilized and all the elastomeric material coupled to the canning lids and used to seal the canning lids to the rims of the canning jars are made tacky.

As used in the present specification and in the appended claims, the term “container” or similar language is meant to be understood broadly as any vessel used to boil home canning lids. Some examples of containers include pots, pans, and pressure cookers, among others.

Even still further, as used in the present specification and in the appended claims, the term “a number of or similar language is meant to be understood broadly as any positive number comprising 1 to infinity; zero not being a number, but the absence of a number.

In the following description, for purposes of explanation, numerous specific details are set forth in order to provide a thorough understanding of the present systems and methods. It will be apparent, however, to one skilled in the art that the present apparatus, systems and methods may be practiced without these specific details. Reference in the specification to “an example” or similar language indicates that a particular feature, structure, or characteristic described in connection with that example is included as described, but may not be included in other examples.

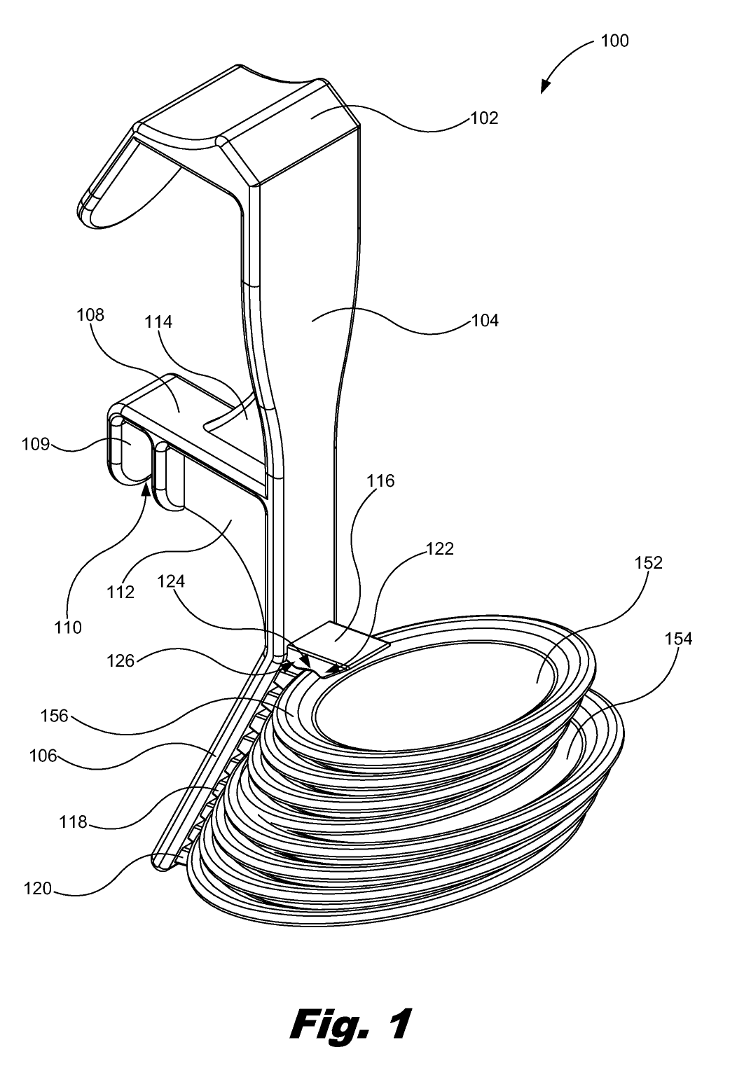

Turning now to the figures, FIG. 1 is a perspective view of a lid sterilization apparatus (100), according to an example of principles described herein. The lid sterilization apparatus (100) and other examples disclosed hereafter may be made of any material that can withstand temperatures as high as at least the temperature of boiling water; 212° F. (100° C.) at 1 atm. In another example, the material from which the lid sterilization apparatus (100) is formed is able to withstand temperatures between approximately 32° F. (0° C.) and 300° F. (149° C.). The material from which the lid sterilization apparatus (100) is made includes, for example, polymers, metals, metal alloys, woods, synthetic rubbers, natural rubbers, and tempered glass, among others.

In one example, the lid sterilization apparatus (100) and other examples disclosed hereafter are made of a polymer material. Examples of polymer materials from which the lid sterilization apparatus (100) is made include biopolymers, copolymers sluoropolymers, latexes, inorganic polymers, phenolic resins, polyanhydrides, polyesters, polyolefins, rubbers, silicones, silicone rubbers, synthetic rubbers, vinyl polymers, and combinations thereof. In another example, the lid sterilization apparatus (100) is made of polyethylene terephthalate (PET), high density polyethylene (HDPE), polyvinyl chloride (PVC), low density polyethylene (LDPE), polypropylene (PP), polystyrene (PS), and combinations thereof,

In another example, the lid sterilization apparatus (100) and other examples disclosed hereafter are made of any material approved by a regulatory body such as, for example, the Food and Drug Administration (FDA), for use in connection with foodstuffs and food preparation. In yet another example, because the lid sterilization apparatus (100) and other examples disclosed hereafter do not come into direct contact with foodstuffs, the lid sterilization apparatus (100) and other examples disclosed hereafter are made of a recycled material. In this example, the lid sterilization apparatus (100) is at least partially made of post-consumer resins (PCRs). The lid sterilization apparatus (100) and other examples disclosed hereafter may be produced using, for example, compression molding, extrusion molding, injection molding, transfer molding, and thermoforming, among others.

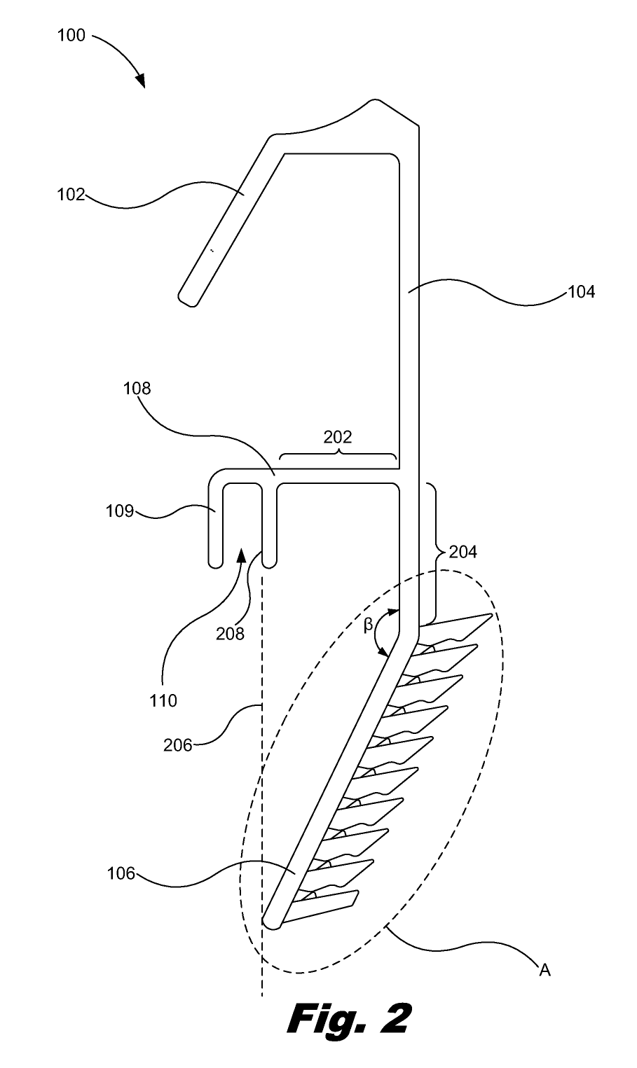

The lid sterilization apparatus (100) comprises a handle (102), a column (104) coupled to the handle (102), and a mounting arm (106) coupled to the column (104). A hook arm (108) is coupled to the column (104). The hook arm (108) comprises a hook (109) that defines a recess (110) within the hook arm (108). As will be discussed in more detail below, the hook (109) of the hook arm (108) provides for the coupling of the lid sterilization apparatus (100) to a container. A first buttress (112) and a second buttress (114) may be provided between portions of the hook arm (108) and the column (104) to provide structural strength between the hook arm (108) and the column (104). Further, the first buttress (112) ensures that a user couples the lid sterilization apparatus (100) to the container via the recess (110) defined in the hook (109) of the hook arm (108), and not to the area defined by the hook arm length (FIG. 2, 202).

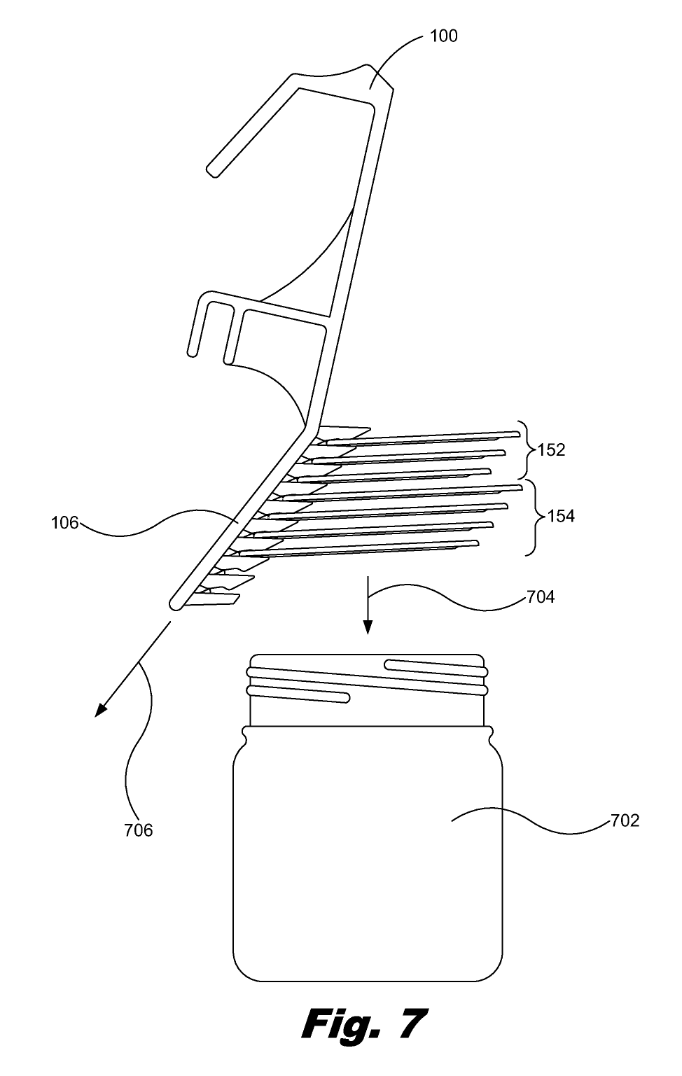

The handle (102) is coupled to the column (104), and allows a user to maneuver the lid sterilization apparatus (100) in order to couple the canning lids (152, 154) to a canning jar (FIG. 7, 702). The canning lids (152, 154) engaged with the lid sterilization apparatus (100) are placed on canning jars as will be described in more detail below in connection with FIG. 7. The handle (102) may be formed in any shape that will provide for maneuvering the lid sterilization apparatus (100). In one example, the handle (102) may include an ergonometric shape that allows a user to better handle and maneuver the lid sterilization apparatus (100) in performing the process of boiling and placing the canning lids (152, 154) onto the canning jars.

The column (104) couples the handle (102) to the horizontal bar (mounting arm (106). The mounting arm (106) comprises a number of fingers (116, 118, 120). Among these fingers (116, 118, 120) are a first finger (116), a number of intermediary fingers (118) and a base finger (120). The first finger (116) and number of intermediary fingers (118) comprise a contour including a distal peak (122) located furthest from the mounting arm (106), a trough (124), and a proximal peak (126) located relatively closer to the mounting arm (106) than the distal peak (122) and trough (124). The distal peak (122), trough (124), and proximal peak (126) form a contour that matches the contour of a canning lid (152, 154) as will be described in more detail below.

FIG. 2 is a cross-sectional side view of the lid sterilization apparatus (100) of FIG. 1, according to an example of principles described herein. The mounting arm (106) is coupled to the column (104) and is positioned at angle β relative to the column (104). In one example, angle β is between approximately 0° and 360° with respect to the column (104). In another example, angle β is between approximately 90° and 270° with respect to the column (104).

In yet another example, angle β is dependent on the distance (202) between the column (104) and an internal surface (208) of the hook (109) of the hook arm (108) located closest to the column (104). So that the mounting arm (106) sits against a wall of a container in which the boiling of the canning lids takes place, the end of the mounting arm (106) located furthest from the column (104) and internal surface (208) of the hook (109) vertically line up on line (206). Thus, angle β is the angle formed when these parameters are met. In one example, distance (202) between the column (104) and an internal surface (208) of the hook (109) is between 0.5 in. and 1.5 in. In another example, the distance (202) between the column (104) and an internal surface (208) of the hook (109) is approximately 1.0 in.

In yet another example, the distance (202) between the column (104) and an internal surface (208) of the hook (109) is adjustable. In this example, the hook arm (108) includes a telescoping device such as, for example, a telescoping cylinder, that allows the distance (202) between the column (104) and an internal surface (208) of the hook (109) to be adjusted. In this example, angle β is also adjustable in order to allow the mounting arm (106) to sit against a wall of a container in which the boiling of the canning lids takes place. This is achieved by pivoting the mounting arm (106) with respect to the column (104). Examples of pivoting elements that may be incorporated into the lid sterilization apparatus (100) in order to allow for the mounting arm (106) to pivot with respect to the column (104) include a ball and socket joint, a barrel hinge, and a butt hinge, among others.

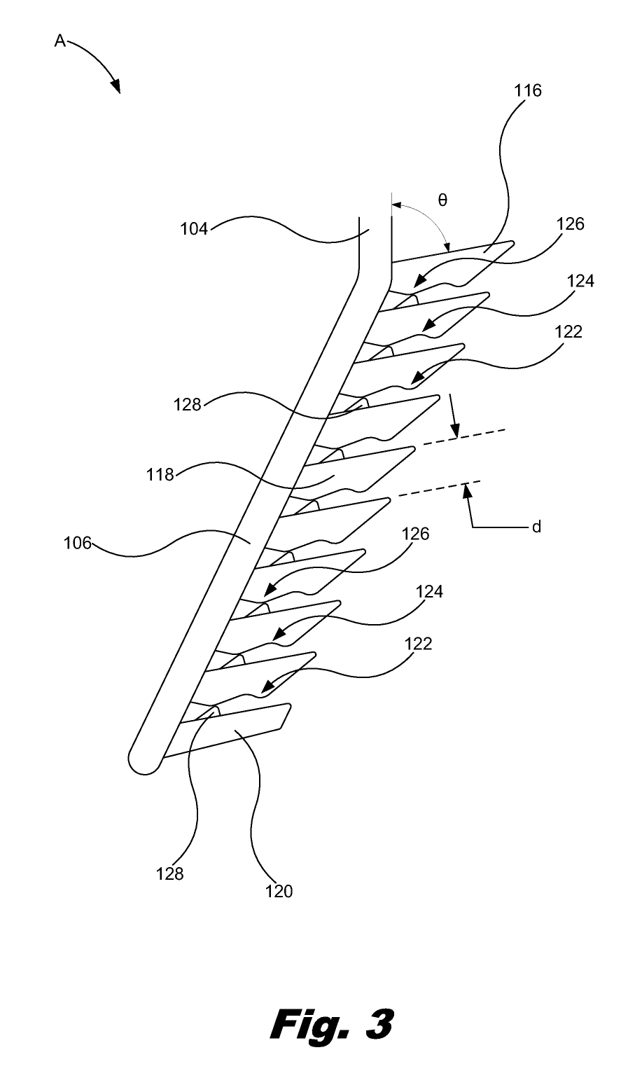

The lid-mounting portion (A) comprising the mounting arm (106) and the number of fingers (116, 118, 120) will now be discussed in more detail in connection with FIG. 3. FIG. 3 is a cross-sectional side view of the lid-mounting portion (A) of the lid sterilization apparatus of FIG. 2, according to an example of principles described herein. As shown in FIG. 3, the fingers (116, 118, 120) are coupled to the mounting arm (106) in a parallel manner and at distance d from one another to form a uniform layout of the fingers (116, 118, 120) with respect to each other. In one example, distance d is approximately equal to the thickness of a canning lid. In another example, distance d is between approximately between 0.1 in and 0.25 in. In still another example, distance d is between approximately 0.2 in.

The first finger (116) is positioned with respect to the column (104) at angle α. Because all the fingers (116, 118, 120) are parallel with respect to one another, all the fingers (116, 118, 120) are positioned at angle α with respect to the column (104). In one example, angle α is between approximately 0° and 120°. In another example, angle α is between approximately 40° and 100°. In still another example, angle α is approximately 80°.

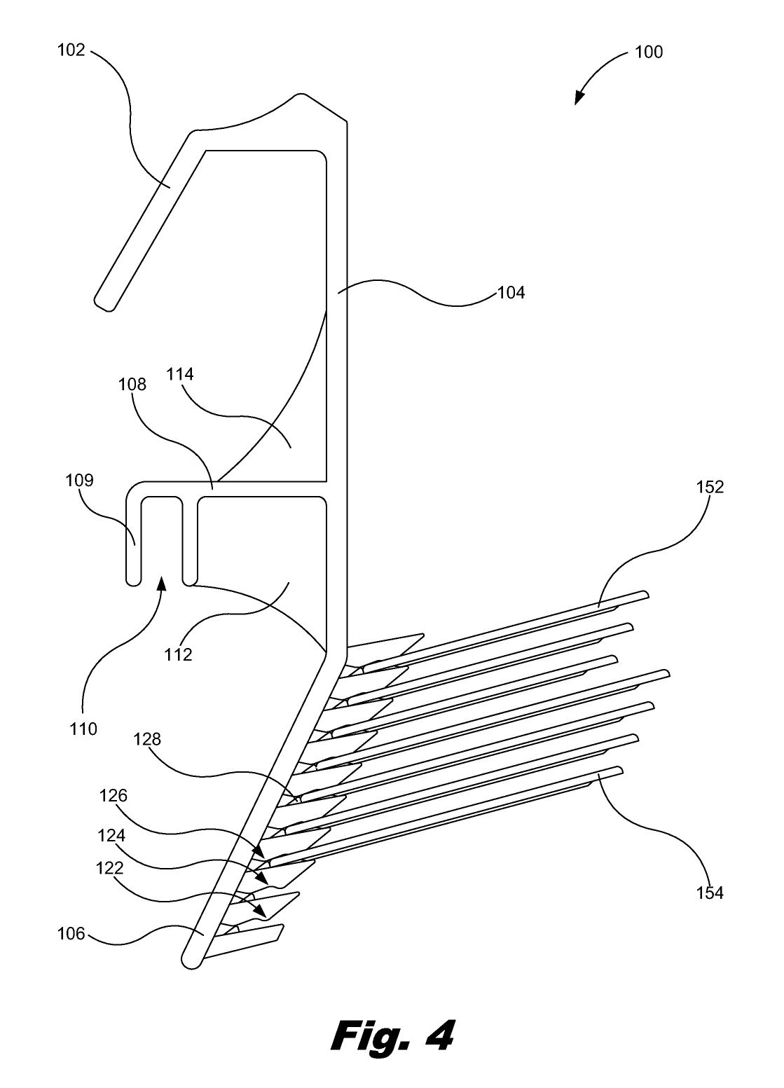

As depicted in detail in FIG. 3, the intermediary fingers (118) and base finger (120) comprise a number of stoppers (128). The stoppers (128) prevent a canning lid that is inserted between the fingers (116, 118, 120) from being pushed beyond a predefined point. FIG. 4 is a side view of the lid sterilization apparatus (100) of FIG. 1 with canning lids (152, 154) engaged therewith, according to an example of the principles described herein. As depicted in FIG. 4, a number of canning lids (152, 154) are engaged between the fingers (116, 118, 120), and abut the stoppers (128). The lid sterilization apparatus (100) can couple with any size of canning lids. In one example, the canning lids may be regular-mouth canning lids (152) used to seal regular mouth canning jars. Regular mouth canning jars have a rim diameter of approximately 2.5 inches or 6.35 cm. In another example, the canning lids may be wide mouth canning lids (154) used to seal wide mouth canning jars. Wide mouth canning jars have a rim diameter of approximately 3.125 inches or 8 cm.

The lid sterilization apparatus (100) may comprise the first finger (116), the base finger (120), and a number of intermediary fingers (118). In this manner, any number of spaces between the fingers (116, 118, 120) may exist to provide for the engagement of any number of canning lids (152, 154). In one example, the lid sterilization apparatus (100) may comprise nine intermediary fingers (118). In this example, the lid sterilization apparatus (100) has 10 spaces between the first finger (116), the 9 intermediary fingers (118), and the base finger (120) allowing for the engagement of 10 canning lids (152, 154). In another example, the number of intermediary fingers (118) is varied depending on the number of canning lids (152, 154) to be engaged with the lid sterilization apparatus (100). In yet another example, the lid sterilization apparatus (100) has enough intermediary fingers (118) coupled to the mounting arm (106) to accommodate for between 1 and 30 canning lids (152, 154) to be engaged with the lid sterilization apparatus (100).

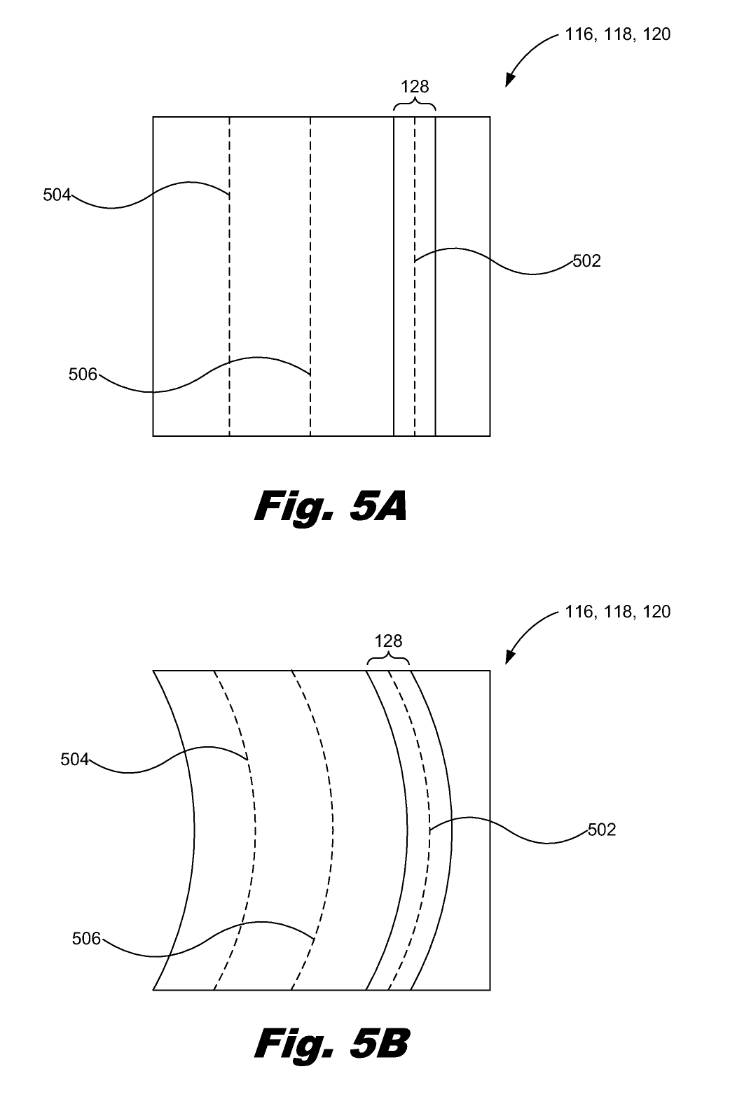

FIG. 5A is a top view of a finger (116, 118, 120) of the lid sterilization apparatus (100), according to an example of the principles described herein. FIG. 5B is a top view of a finger (11, 118, 120) of the lid sterilization apparatus (100), according to another example of the principles described herein. As depicted in FIGS. 5A and 5B, the intermediary fingers (118) and base finger (120) comprise a stopper (128). The maximum of the proximal peak (126) of either the intermediary finger (118) or first finger (116) directly above the intermediary fingers (118) or base finger (120) is indicated by the dotted line (502). Thus, the maximum of the proximal peak (502) is located approximately above the center of the stopper (128). In this manner, the stopper (128) and proximal peak (126) form a structure to which the canning lid (152, 154) can abut and between which the canning lids (152, 154) can be compressed. The canning lids (152, 154) are tightly engaged with the lid sterilization apparatus (100) by the stopper (128) and proximal peak (126).

The top finger (116) and intermediary fingers (118) of FIGS. 5A and 5B also comprise a distal peak (122) and a trough (124) comprising maximums indicated by lines 504 and 506, respectively. With reference to FIGS. 2, 3, 4, 5A, and 5B, the distal peak (122) and a trough (124) form a contour that approximately matches and mates with the contour of a canning lid (152, 154). A canning lid (152, 154) comprises a lip (FIG. 1, 156) around its circumference. The lip (156) accommodates a rubber ring located on the underside of the canning lid (152, 154). Because the contour formed by the distal peak (122) and trough (124) match and mate with the lip (FIG. 1, 156) of the canning lid (152, 154), the canning lid (152, 154) is tightly engaged with the lid sterilization apparatus (100).

FIGS. 5A and 5B depict different shapes of the fingers (116, 118, 120). In the example of FIG. 5A, the fingers (116, 118, 120) have an approximately square shape when viewed from the top. The example of FIG. 5B, however, has a square shape on the end of the fingers (116, 118, 120) where the stopper (128) resides, but has a curved edge (508) on the end where the distal peak (122) resides. Further, the stopper (128), distal peak (122), trough (124) and proximal peak (126) are concentrically curved with respect to the curved edge (508). The curved edge (508) and concentrically curved stopper (128), distal peak (122), trough (124) and proximal peak (126) allow for better matching and mating with the curved lip (FIG. 1, 156) of the canning lids (152, 154). In one example, the radius of a circle formed by the curved edge (508) and concentrically curved stopper (128), distal peak (122), trough (124) and proximal peak (126) (i.e., the finger radius) is equal to the radius of the lip (FIG. 1, 156) of the canning lid (152, 154). In another example, because the radius of a regular mouth canning lid (152) is shorter than the radius of a wide mouth canning lid (154) the finger radius is an average of the radius of a regular mouth canning lid (152) and a wide mouth canning lid (154). In yet another example, the finger radius of the finger of FIG. 5B is approximately equal to the radius of a regular-mouth canning lid (152). In still another example, the finger radius of the finger of FIG. 5B is approximately equal to the radius of a wide-mouth canning lid (154).

With regard to FIGS. 1 through 5B, the various elements of the lid sterilization apparatus (100), in one example, are formed as a single integrated piece. In another example, the various elements of the lid sterilization apparatus (100), in one example, are attached to each other via various coupling processes including, for example, welding, gluing, etc.

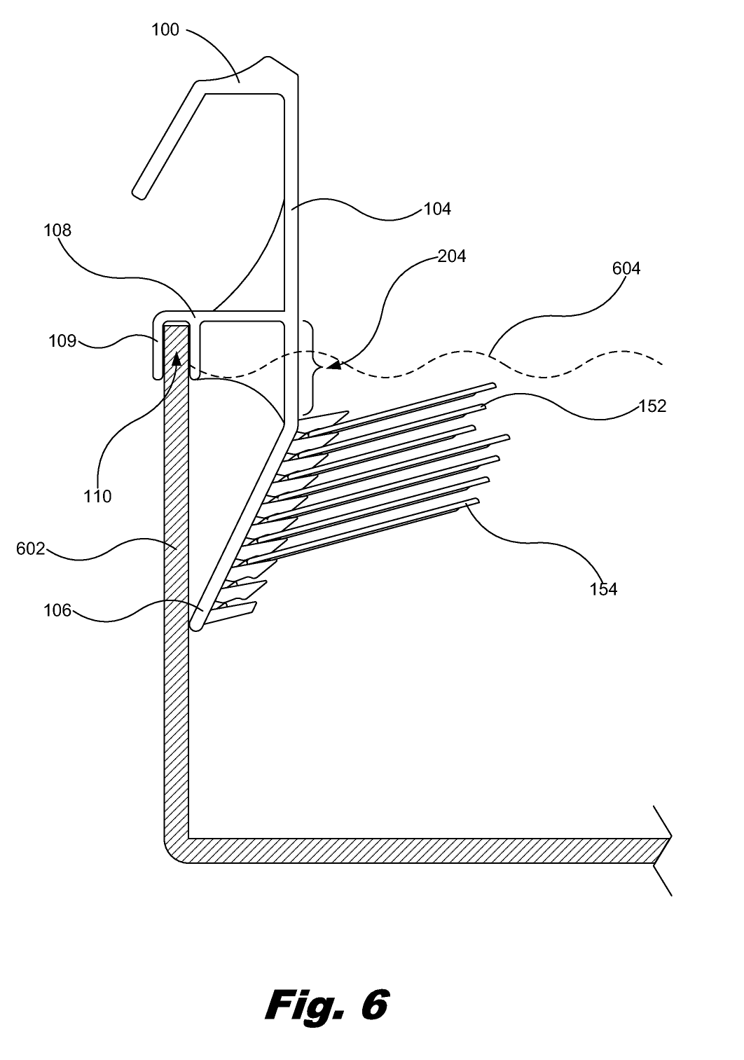

FIG. 6 is a cross-sectional side view of a lid sterilization apparatus (100) engaged with a container (602) for boiling of the canning lids (152, 154), according to an example of the principles described herein. As depicted in FIG. 6, the lid sterilization apparatus (100) is coupled to the container (602) via the recess (110) of the hook (109) of the hook arm (108). The mounting arm (106) rests against the inside of the container (602). A water level indicated by line 604 reaches above the level of the first finger (116) and a canning lid (152, 154) engaged between the first finger (116) and the first intermediary finger (118). In this manner, all the canning lids (152, 154) engaged within the lid sterilization apparatus (100) are covered by water. This ensures that all the canning lids (152, 154) are exposed to boiling water.

As described above, exposing canning lids (152, 154) to boiling water sterilizes the canning lids (152, 154) in preparation for the preservation of the foodstuff to be preserved. Further, this process of boiling the canning lids (152, 154) loosens up and prepares rubber gaskets integrated into the underside of the canning lids (152, 154). Loosening up the rubber gaskets of the canning lids (152, 154) provides for better adhesion of the canning lids (152, 154) to the rims of canning jars, and helps to ensure sealing of the canning jars during pressure cooking of the canning jars.

In one example, the distance (204) between the top of the hook arm (108) and top of the first finger (116) is determined based on the intended height of the water level (604). In another example, the column (104) is adjustable between the top of the hook arm (108) and top of the first finger (116) to provide for varying heights of the water level (604). In this example, the column (104) includes a telescoping device such as, for example, a telescoping cylinder, that allows the distance (204) between the top of the hook arm (108) and top of the first finger (116) to be adjusted.

FIG. 7 is a side view of a lid sterilization apparatus of FIG. 1 used to engage a canning lid (152, 154) onto a canning jar (702), according to an example of the principles described herein. Once the canning lids (152, 154) have been sufficiently exposed to boiling water as described above in connection with FIG. 6, the canning lids (152, 154) may be applied to the canning jars (152, 154). FIG. 7 depicts how the canning lids (152, 154) are applied to the canning jars (702). The canning lids (152, 154) engaged in the lid sterilization apparatus (100) are brought into alignment with the canning jar (702). Once an approximate alignment has been achieved, the canning lid (154) closest to the canning jar (702) is moved down onto the canning jar (702) in the direction of arrow 704. When the canning lid (154) touches the rim of the canning jar (702), the user applies pressure to the sides of the canning lid (154) to release the canning lid (154) from the lid sterilization apparatus (100) and place the canning lid (154) on the rim of the canning jar (702). In the example of FIG. 7, a wide-mouth canning lid (154) is being placed on a wide-mouth canning jar (702). However, the same process may be utilized for any size of canning lid and canning jar combinations.

As the canning lids (152, 154) are disposed on a number of canning jars (702), the mounting arm (106) moves away from the canning jar (702) in the direction of arrow 706. This is due to the angle β at which the mounting arm (106) is coupled to the column (104). In this example, angle β of FIG. 2 is an angle at which a portion of the lid sterilization apparatus (100, 900) such as the fingers (116, 118, 120) or the mounting arm (106) do not come into contact with the canning jar (702) or obstruct the canning lid (152, 154) application process.

In light of the above description of FIGS. 6 and 7, the lid sterilization apparatus (100) ensures complete sterilization of each individual canning lid (152, 154) and assists in the placement of the canning lids (152, 154) on the canning jars (702) without exposing a user to potential safety issues such as burns from boiling water or hot elements.

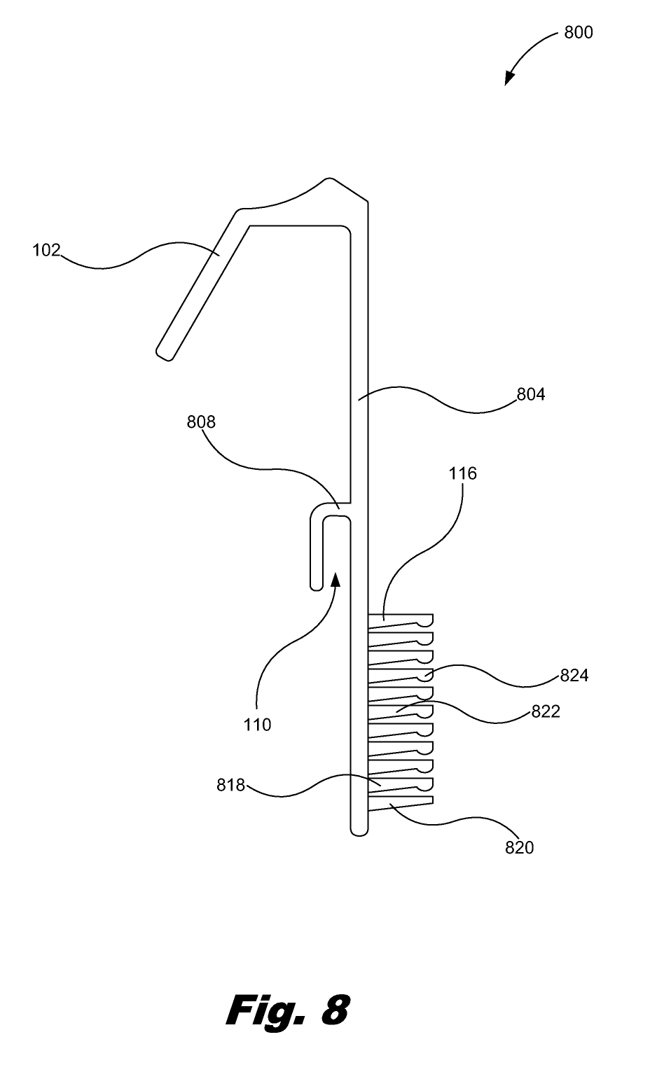

FIG. 8 is a cross-sectional side view of a lid sterilization apparatus (800), according to another example of principles described herein. The lid sterilization apparatus (800) of FIG. 8 comprises a handle, a column (804), and a hook (808) defining a recess (110) for coupling to a container (FIG. 6, 602). In the example of FIG. 8, the column (804) is approximately straight, and runs approximately the full length of the lid sterilization apparatus (800). The hook (808) extends directly from the column (804). In this manner, the column (804) of the lid sterilization apparatus (800), when coupled to a container (FIG. 6, 602) via the hook (808), sits directly against the container (FIG. 6, 602).

A first finger (816), a number of intermediary fingers (818), and a base finger (820) are coupled to the column (804). The fingers (816, 818, 820) of the lid sterilization apparatus (800) comprise a tapered body (822), and the first finger (816) and intermediary fingers (818) comprise a protrusion (824). The tapered body (822) of the fingers (816, 818, 820) creates a tapering space between the fingers (816, 818, 820) between which the canning lids (154, 152) can be wedged. The protrusion (824) moves over and behind the lip (FIG. 1, 156) of the canning lids (152, 154), and removably locks the canning lids between the fingers (816, 818, 820). The tapered body (822) and protrusion (824) form a contour that approximately matches and mates with the contour of the lip (FIG. 1, 156) of a canning lid (152, 154). In this manner, the canning lids (152, 154) are secured to the lid sterilization apparatus (800).

In one example, the protrusion (824) is made of a resilient material. In this example, the protrusions (824) deform when a canning lid (152, 154) is engaged with the fingers (816, 818, 820) of the lid sterilization apparatus (800) and return to their original form when the lips (FIG. 1, 156) of the canning lids (152, 154) pass the protrusions (824). Examples of resilient materials that the protrusions may be made of include silicones, rubbers, and latexes, among others.

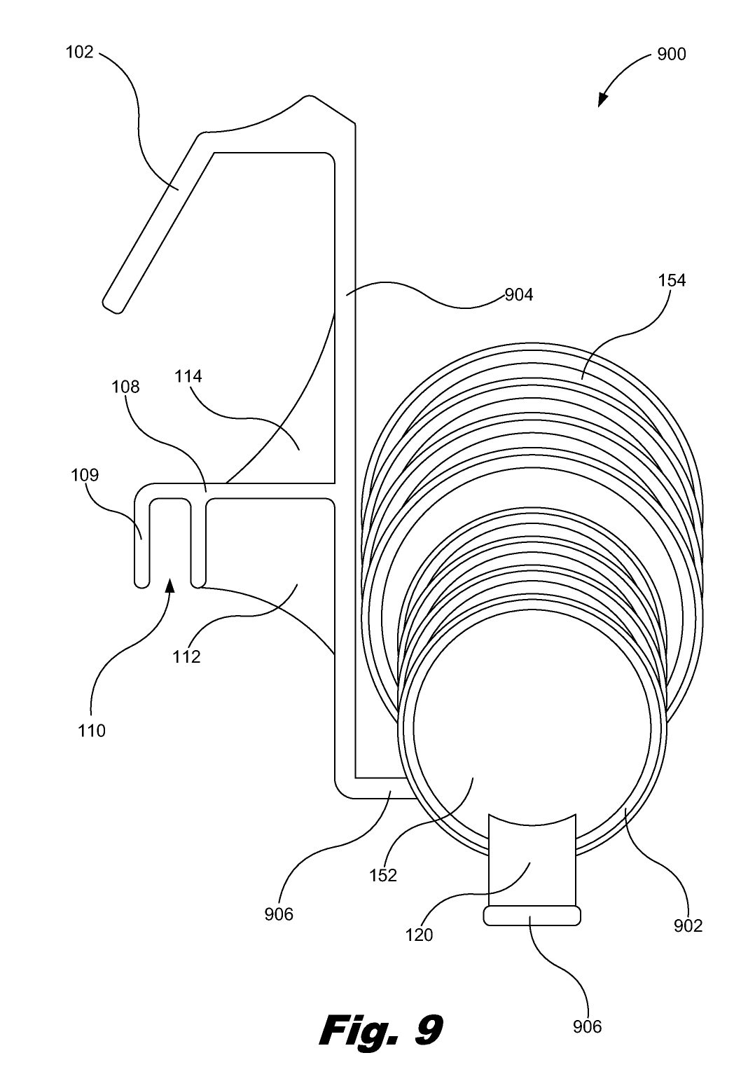

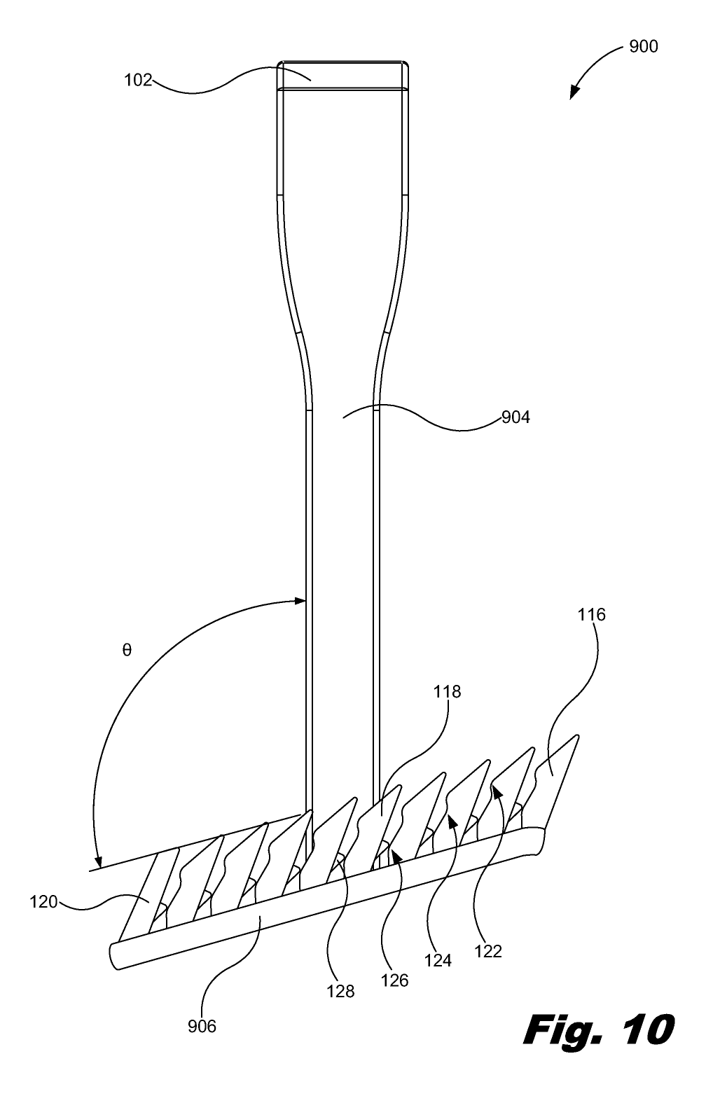

FIG. 9 is a side view of a lid sterilization apparatus (900), according to still another example of principles described herein. FIG. 10 is a front view of the lid sterilization apparatus (900) of FIG. 9, according to an example of principles described herein. The lid sterilization apparatus (900) comprises a handle (102), a column (904) coupled to the handle (102), a horizontal bar (908) coupled to the column (904), and a mounting arm (906) coupled to the horizontal bar (908). A hook arm (108) is coupled to the column (104). The hook arm (108) comprises a hook (109) that defines a recess (110) within the hook arm (108). A first buttress (112) and a second buttress (114) may be provided between portions of the hook arm (108) and the column (104) to provide structural strength between the hook arm (108) and the column (104). Further, the first buttress (112) ensures that a user couples the lid sterilization apparatus (100) to the container via the recess (110) defined in the hook (109) of the hook arm (108) and not a recess that would exist if the first buttress (112) were not present.

In the example of FIG. 9, the hook arm (108) extends the hook (109) away from the column (904). However, in another example, the hook (109) extends directly from the column (904), and the example does not include a hook arm (108). In this manner, the column (904) of the lid sterilization apparatus (900), when coupled to a container (FIG. 6, 602) via the hook (109), sits directly against the container (FIG. 6, 602).

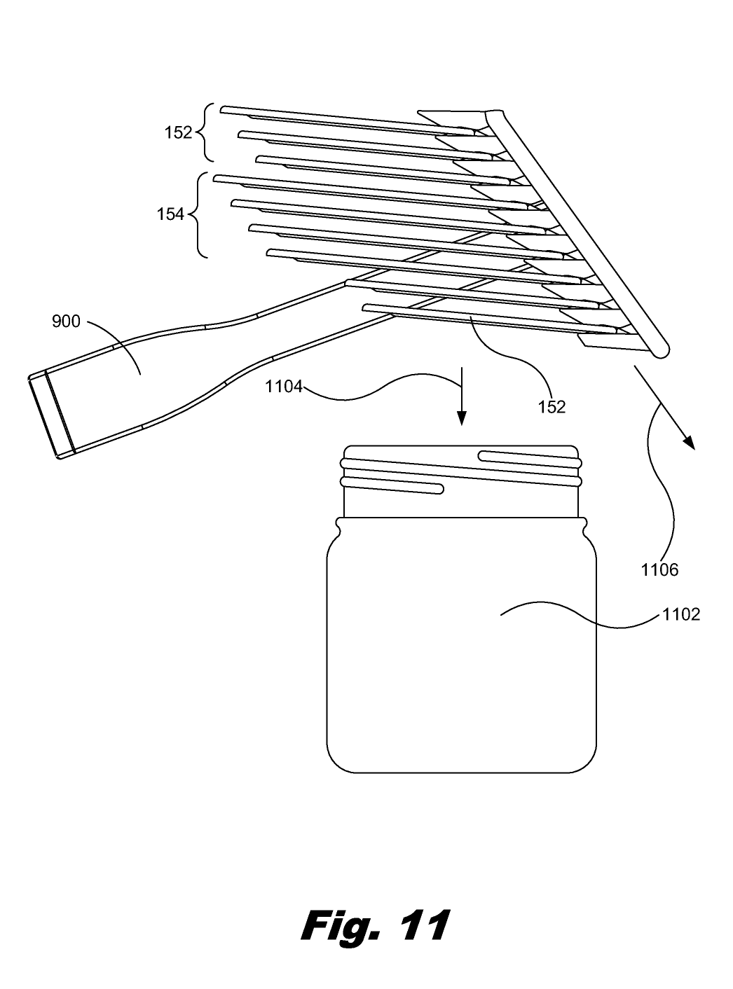

The handle (102) is coupled to the column (904), and allows a user to maneuver the lid sterilization apparatus (900) in order to couple the canning lids (152, 154) to a canning jar (FIG. 11, 1102). The canning lids (152, 154) engaged with the lid sterilization apparatus (900) are placed on canning jars as will be described in more detail below in connection with FIG. 11. The handle (102) may be formed in any shape that will provide for maneuvering the lid sterilization apparatus (900). In one example, the handle (102) may include an ergonometric shape that allows a user to better handle and maneuver the lid sterilization apparatus (900) in performing the process of boiling and placing the canning lids (152, 154) onto the canning jars.

The column (904) couples the handle (102) to the horizontal bar (906), and, in turn, to the mounting arm (FIGS. 9 and 10, 906). The mounting arm (106) comprises a number of fingers (116, 118, 120) as described above in connection with FIGS. 1 through 5B.

As depicted in FIGS. 9 and 10, the mounting arm (106) is coupled to the horizontal bar (906) at angle θ with respect to the column (904). In one example, angle θ is between approximately 0° and 360° with respect to the column (904). In another example, angle θ is between approximately 90° and 270° with respect to the column (904). In still another example, angle θ is approximately 110° with respect to the column (904).

The number of intermediary fingers (118) and base finger (120) include stoppers (128), and the first finger (116) and intermediary fingers comprise distal peaks (122), troughs (124), and proximal peaks (126), 120) as described above in connection with FIGS. 1 through 5B. In the present example of FIG. 9, a base finger (120) of the example described in connection with FIG. 5B is depicted. However, in another example, the base finger of the example of FIG. 5A may be utilized in connection with FIG. 9.

The canning lids (152, 154) in this example and other examples described herein comprise a lip (FIG. 1, 156) as described above. The lip (FIG. 1, 156) is provided on a canning lid (152, 154) for several reasons. One reason is to allow for a place for the rim of a canning jar (702, 1102) to seat with a portion of the canning lids (152, 154) along the circumference of the canning lids (152, 154). The side of the canning lids (152, 154) opposite the lip (FIG. 1, 156) comprises an indentation in which the rim of the canning jar (702, 1102) seats.

Another reason the canning lids (152, 154) are provided with a lip (FIG. 1, 156) is to give place for a layer of elastomeric material (902) on the side of the canning lids (152, 154) opposite the lip (FIG. 1, 156). In one example, the elastomeric material (902) may comprise a gasket that is incorporated into the canning lids (152, 154) directly underneath the lip (FIG. 1, 156). In another example, the elastomeric material (902) may comprise a separate gasket that seats into the canning lids (152, 154) directly underneath the lip (FIG. 1, 156). The elastomeric material (902) provides a seal between the canning lids (152, 154) and the canning jars (702, 1102), and ensures that the foodstuffs preserved within the canning jars (702, 1102) are hermetically sealed from the environment.

The descriptions of the various examples herein provide for the safe boiling and application of the canning lids (152, 154) to the canning jars (702, 1102) without contamination from the environment. Further, these various examples provide for the loosening up of the elastomeric material (902) located on the underside of the canning lids (152, 154). Boiling of the canning lids (152, 154) sterilizes the canning lids (152, 154). Further, boiling the canning lids (152, 154) also increases the elasticity or tackiness of the elastomeric material (902). This provides the canning lids (152, 154) with an adhesive property between the canning lids (152, 154) and the canning jars (702, 1102). This adhesive property helps to ensure a seal between the canning lids (152, 154) and the canning jars (702, 1102). The examples described herein provide for the individual application of heat to each canning lid (152, 154) via the boiling process.

Without the examples of the lid sterilization apparatus (100, 800, 900, 1200, 1400) described herein, a user would simply place canning lids (152, 154) into the bottom of a container for boiling. This method of boiling canning lids does not always provide for complete sterilization of each lid and does not ensure that the elastomeric material (902) will be rendered tacky. For example, a number of canning lids (152, 154), during the boiling process may mate with one another, leaving at least the bottom side of one canning lid (152, 154) and the top side of another canning lid (152, 154) unexposed to the boiling water. This may leave the mated sides of the canning lids (152, 154) unsterilized, and may prohibit the elastomeric material (902) of the top canning lid (152, 154) from becoming tacky. The examples described herein ensure that the above disadvantages are alleviated, and, in turn, ensures a sterilized and hermetically sealed canning jar (702, 1102).

Turning now to the figures again, FIG. 11 is a front view of the lid sterilization apparatus (900) of FIGS. 9 and 10 used to engage a lid onto a container, according to an example of the principles described herein. Once the canning lids (152, 154) have been sufficiently exposed to boiling water as described above in connection with FIG. 6, the canning lids (152, 154) may be applied to the canning jars (152, 154). FIG. 11 depicts how the canning lids (152, 154) are applied to the canning jars (1102). The canning lids (152, 154) engaged in the lid sterilization apparatus (100) are brought into alignment with the canning jar (1102). Once an approximate alignment has been achieved, the canning lid (152) closest to the canning jar (1102) is moved down onto the canning jar (1102) in the direction of arrow 1104. When the canning lid (152) touches the rim of the canning jar (1102), the user applies pressure to the sides of the canning lid (152) to release the canning lid (152) from the lid sterilization apparatus (900) and place the canning lid (152) on the rim of the canning jar (1102). In the example of FIG. 11, a regular-mouth canning lid (152) is being placed on a regular-mouth canning jar (1102). However, the same process may be utilized for any size of canning lid and canning jar combinations.

As the canning lids (152, 154) are disposed on a number of canning jars (1102), the mounting arm (106) moves away from the canning jar (1102) in the direction of arrow 1106. In this manner, the mounting arm (106) does not come into contact with the canning jar (1102) and does not obstruct the canning lid (152, 154) application process.

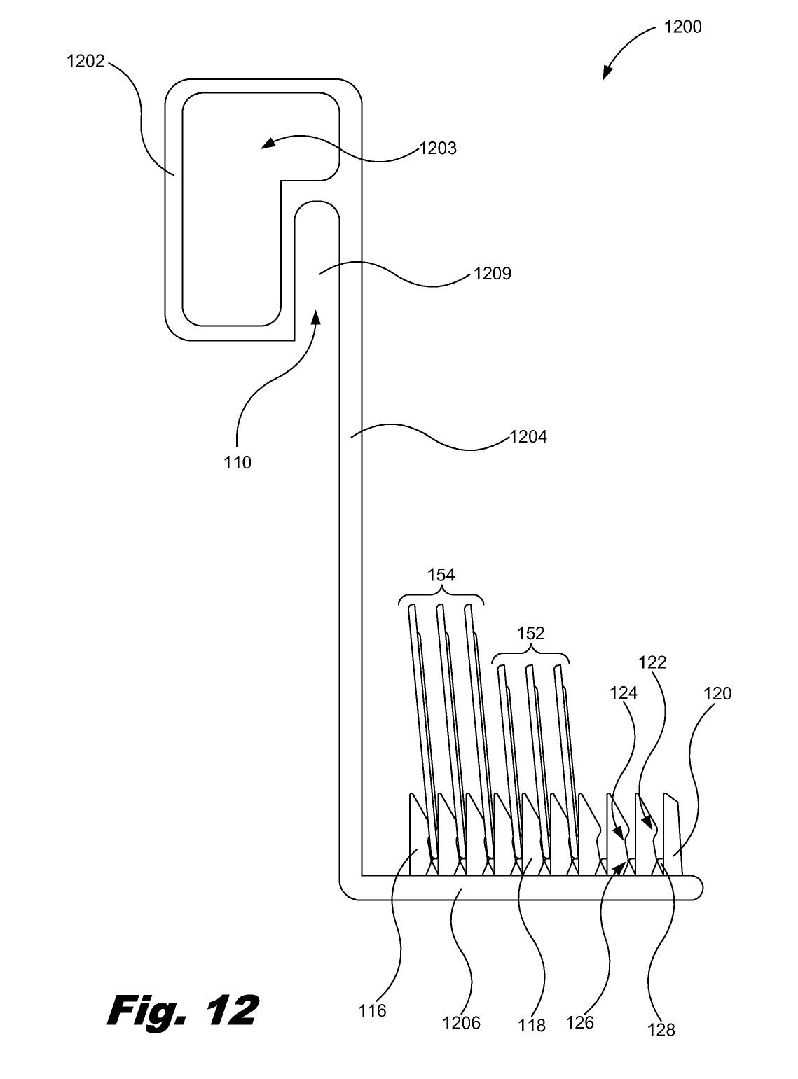

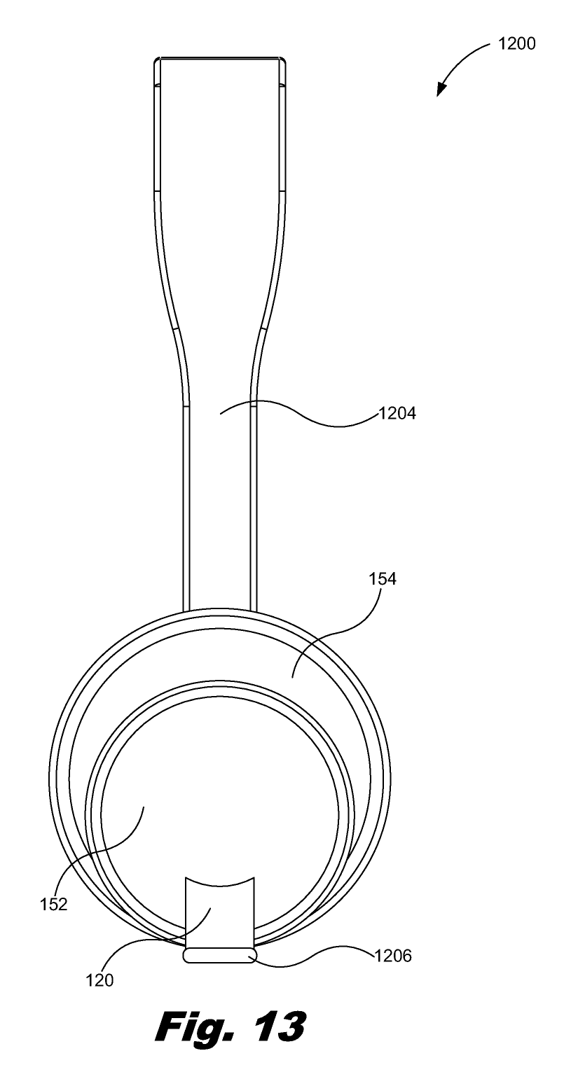

FIG. 12 is a side view of a lid sterilization apparatus (1200) with canning lids engaged therewith, and FIG. 13 is a front view of the lid sterilization apparatus of FIG. 12, according to still another example of the principles described herein. The lid sterilization apparatus (1200) comprises a handle (1202), a column (1204) coupled to the handle (102), and a mounting arm (1206) perpendicularly coupled to the column (1204). A hook (1209) is formed between the handle (1202) and the column (1204). The hook (1209) defines a recess (110) and provides for the coupling of the lid sterilization apparatus (1200) to a container (FIG. 6, 602). In this manner, the column (1204) of the lid sterilization apparatus (1200), when coupled to a container (FIG. 6, 602) via the hook (1209), sits directly against the container (FIG. 6, 602).

The handle (1202) is coupled to the column (1204), and allows a user to maneuver the lid sterilization apparatus (1200) in order to couple the canning lids (152, 154) to a canning jar (FIG. 7, 702, FIG. 11, 1102). The canning lids (152, 154) engaged with the lid sterilization apparatus (1200) are placed on canning jars as described above in connection with FIGS. 7 and 11.

The handle (1202) may be formed in any shape that will provide for maneuvering the lid sterilization apparatus (1200). In the example of FIG. 12, the handle (1202) defines a void (1203) therein. The void (1203) accommodates a number of a user's fingers, and assists a user in grasping the lid sterilization apparatus (1200). The handle (1202) may include an ergonometric shape that allows a user to better handle and maneuver the lid sterilization apparatus (1200) in performing the process of boiling and placing the canning lids (152, 154) onto the canning jars (FIG. 7, 702, FIG. 11, 1102).

The column (1204) couples the handle (1202) to the mounting arm (1206). The mounting arm (1206) comprises a number of fingers (116, 118, 120) as described above in connection with FIGS. 1 through 5B.

As depicted in FIGS. 12 and 13, the mounting arm (1206) is coupled to the column (1204) approximately perpendicular to the column (1204), and in the opposite direction in which the handle (1202) extends from the column (1204). In this manner, the mounting arm (1206) projects away from the front of the column (1204) as depicted in FIGS. 12 and 13.

The number of intermediary fingers (118) and base finger (120) include stoppers (128), and the first finger (116) and intermediary fingers comprise distal peaks (122), troughs (124), and proximal peaks (126), 120) as described above in connection with FIGS. 1 through 5B. In the present example of FIG. 13, a base finger (120) of the example described in connection with FIG. 5B is depicted. However, in another example, the base finger of the example of FIG. 5A may be utilized in connection with FIGS. 12 and 13. The fingers (116, 118, 120) are approximately horizontally aligned along the length of the mounting arm (1206).

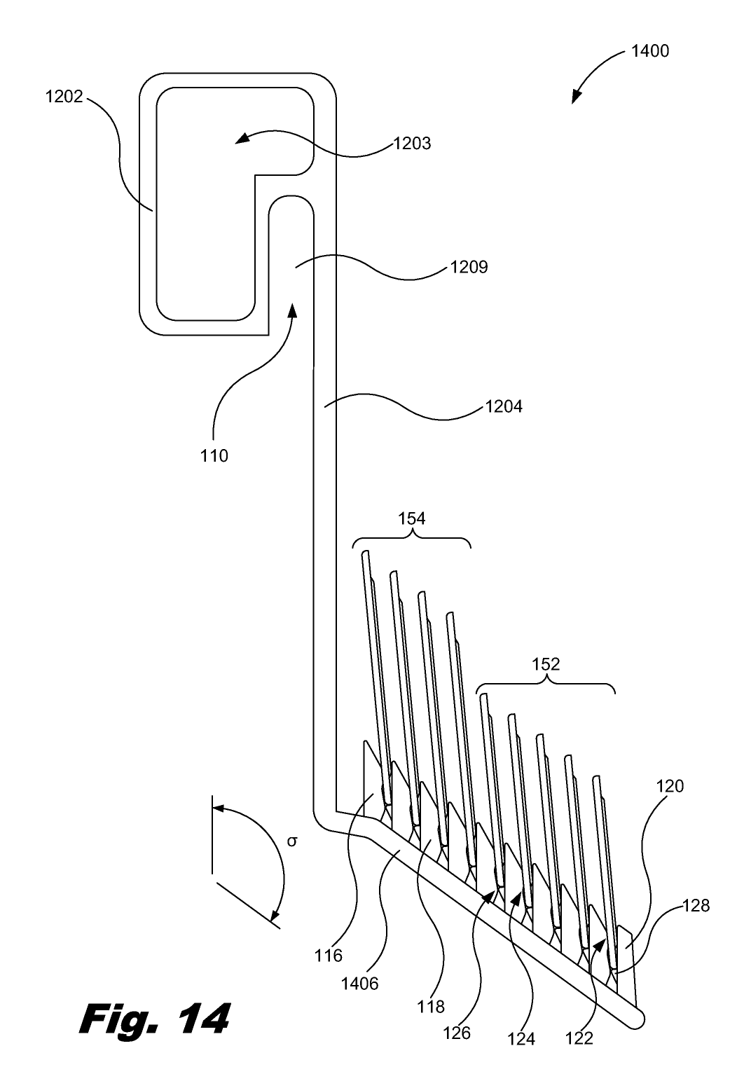

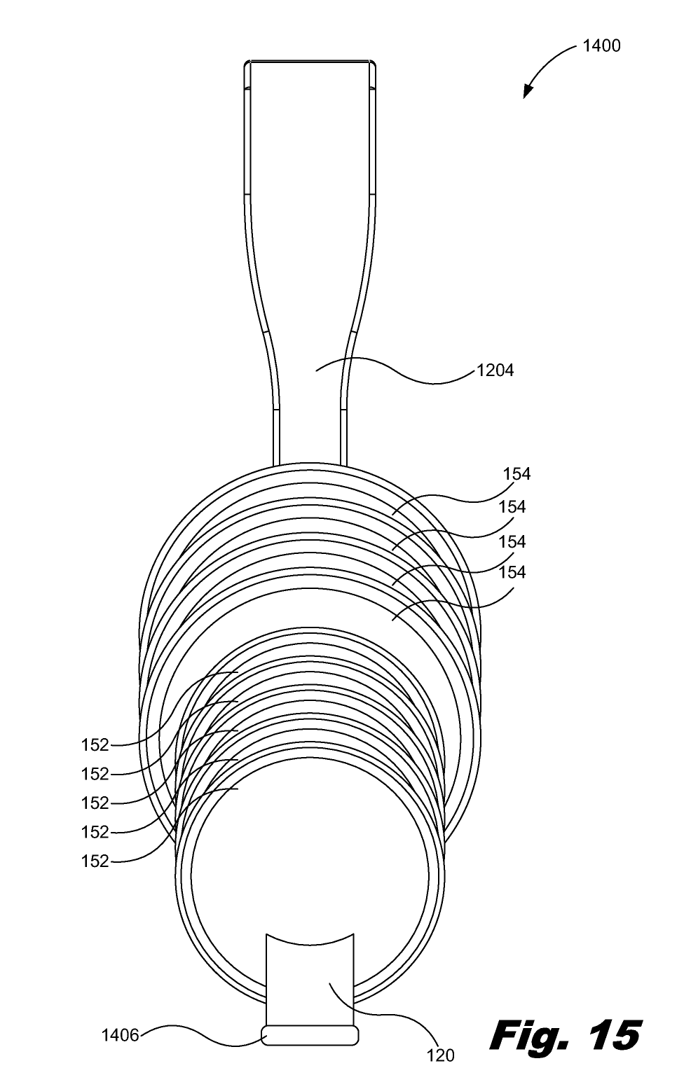

FIG. 14 is a side view of a lid sterilization apparatus with canning lids engaged therewith, and FIG. 15 is a front view of the lid sterilization apparatus of FIG. 14, according to still another example of the principles described herein. The lid sterilization apparatus (1400) comprises a handle (1202), a column (1204) coupled to the handle (102), and a mounting arm (1406) coupled to the column (1204) at an angle with respect to the column (1204).

A hook (1209) is formed between the handle (1202) and the column (1204). The hook (1209) defines a recess (110) and provides for the coupling of the lid sterilization apparatus (1400) to a container (FIG. 6, 602). In this manner, the column (1204) of the lid sterilization apparatus (1400), when coupled to a container (FIG. 6, 602) via the hook (1209), sits directly against the container (FIG. 6, 602).

The handle (1202) is coupled to the column (1204), and allows a user to maneuver the lid sterilization apparatus (1400) in order to couple the canning lids (152, 154) to a canning jar (FIG. 7, 702, FIG. 11, 1102). The canning lids (152, 154) engaged with the lid sterilization apparatus (1400) are placed on canning jars (FIG. 7, 702, FIG. 11, 1102) as described above in connection with FIGS. 7 and 11.

The handle (1202) may be formed in any shape that will provide for maneuvering the lid sterilization apparatus (1400). In the example of FIG. 14, the handle (1202) defines a void (1203) therein. The void (1203) accommodates a number of a user's fingers, and assists a user in grasping the lid sterilization apparatus (1400). The handle (1202) may include an ergonometric shape that allows a user to better handle and maneuver the lid sterilization apparatus (1400) in performing the process of boiling and placing the canning lids (152, 154) onto the canning jars (FIG. 7, 702, FIG. 11, 1102).

The column (1204) couples the handle (1202) to the mounting arm (1406). The mounting arm (1406) comprises a number of fingers (116, 118, 120) as described above in connection with FIGS. 1 through 5B.

As depicted in FIGS. 14 and 15, the mounting arm (1406) is coupled to the column (1204) at an angle with respect to the column (1204), and in the opposite direction in which the handle (1202) extends from the column (1204). In this manner, the mounting arm (1406) projects away from the front of the column (1204) as depicted in FIGS. 14 and 15. The mounting arm (1406) is coupled to the column (1204) at an angle σ with respect to the column (1204). In one example, angle σ is between approximately 90° and 270°. In another example, angle σ is between approximately 90° and 180°. In still another example, angle σ is approximately 130°.

The number of intermediary fingers (118) and base finger (120) include stoppers (128), and the first finger (116) and intermediary fingers comprise distal peaks (122), troughs (124), and proximal peaks (126), 120) as described above in connection with FIGS. 1 through 5B. In the present example of FIG. 15, a base finger (120) of the example described in connection with FIG. 5B is depicted. However, in another example, the base finger of the example of

FIG. 5A may be utilized in connection with FIGS. 14 and 15. The fingers (116, 118, 120) are approximately horizontally aligned along the length of the mounting arm (1406).

The specification and figures describe a lid sterilization apparatus. The lid sterilization apparatus comprises a number of fingers to retain a number of canning lids between the fingers. The fingers comprise a contour that matches the contour of a canning lid, and a stopper to prevent a canning lid from being inserted between the fingers beyond a predefined point. This lid sterilization apparatus may have a number of advantages, including: (1) individual separation of canning lids that limits touching of sterilized lids; (2) reduction of potential injuries to a user because the user does not fish out lids from the bottom of a container of boiling water; (3) individual separation of canning lids that ensures that all lids are sufficiently sterilized and all the elastomeric material used to seal the canning lids to the rims of the canning jars are made tacky.

The preceding description has been presented to illustrate and describe examples of the principles described. This description is not intended to be exhaustive or to limit these principles to any precise form disclosed. Many modifications and variations are possible in light of the above teaching.

What is claimed is:

1. A lid sterilization apparatus comprising:
a number of fingers to retain a number of canning lids between the fingers, the fingers comprising:
a contour that matches the contour of a canning lid; and
a stopper to prevent a canning lid from being inserted between the fingers beyond a predefined point.

2. The lid sterilization apparatus of claim 1, in which the contour that matches the contour of a canning lid comprises a contour that matches the lip of a canning lid.

3. The lid sterilization apparatus of claim 1, in which the stopper is positioned so that when a canning lid abuts the stopper, the contour of the finger mates with the contour of the canning lid.

4. The lid sterilization apparatus of claim 1, further comprising:
a mounting arm coupled to the number of fingers;
a column coupled to the mounting arm; and
a handle coupled to the column.

5. The lid sterilization apparatus of claim 4, further comprising a hook arm coupled to the column, the hook arm comprising:
a hook defining a recess within the hook arm, in which the recess of the hook receives a wall of a container.

6. The lid sterilization apparatus of claim 4, in which the mounting arm is coupled to the column at an angle with respect to the column.

7. The lid sterilization apparatus of claim 6, in which the angle at which the mounting arm is coupled to the column is an angle at which a portion of the lid sterilization apparatus does not come into contact with the canning jar.

8. The lid sterilization apparatus of claim 6, in which the angle at which the mounting arm is coupled to the column is dependent on a distance between the column and an internal surface of the hook located closest to the column, in which the end of the mounting arm not coupled to the column is vertically aligned with the internal surface of the hook.

9. The lid sterilization apparatus of claim 6, in which the angle at which the mounting arm is coupled to the column is adjustable via a pivot.

10. The lid sterilization apparatus of claim 1, in which the distance between adjacent fingers is approximately equal to the thickness of a canning lid.

11. The lid sterilization apparatus of claim 4, the distance of the column between the top of the hook arm and top of a first finger is determined based on the intended height of the water level within a container.

12. The lid sterilization apparatus of claim 9, in which the column comprises a telescoping cylinder to adjust the distance between the top of the hook arm and top of the first finger.

13. A mounting arm of a canning lid sterilization apparatus comprising:
a number of fingers coupled to the mounting arm to engage with a number of canning lids, in which the fingers comprise:
a first finger comprising:
a distal peak located furthest from the mounting arm;
a proximal peak located relatively closer to the mounting arm than the distal peak; and
a trough located between the distal peak and the proximal peak;
a number of intermediary fingers comprising:
the distal peak;
the proximal peak; and
the trough; and
a stopper to prevent a canning lid from being inserted between the fingers beyond a predefined point; and
a base finger comprising the stopper to prevent a canning lid from being inserted between the fingers beyond a predefined point.

14. The mounting arm of claim 13, in which the distal peaks, troughs, and proximal peaks of the first finger and intermediary fingers form a contour that matches the contour of a lip of a canning lid.

15. The mounting arm of claim 13, in which the distal peaks, troughs, and proximal peaks of the first finger and intermediary fingers comprise a radial curve that matches the radius of a canning lid.

16. A lid sterilization apparatus comprising:
a handle;
a column coupled to the handle;
a horizontal arm perpendicularly coupled to the column;
a mounting arm coupled to the horizontal arm; and
a number of fingers coupled to the mounting arm to retain a number of canning lids between the fingers,
in which the mounting arm is coupled to the horizontal bar approximately perpendicular to the column and horizontal bar.

17. The lid sterilization apparatus of claim 16, further comprising a hook coupled to the column to couple the lid sterilization apparatus to a container.

18. The lid sterilization apparatus of claim 16, in which the fingers comprise:
a first finger;
a number of intermediary fingers; and
a base finger,
in which the first finger, number of intermediary fingers, and base finger comprise a tapered body to wedge the canning lids into; and
in which the first finger and intermediary fingers comprise a number of protrusions to removably lock a canning lid (152, 154) between the fingers (816, 818, 820).

19. The lid sterilization apparatus of claim 18, in which the protrusions are made of a resilient material.

20. The lid sterilization apparatus of claim 16, in which the lid sterilization apparatus is made of a polymer material.
